(19) United States
(12) Patent Application Publication
(10) Pub. No.: US 2026/0301429 A1
(43) Pub. Date: Oct. 1, 2026

(54) REAL-TIME OCCUPANT IDENTIFICATION USING FACIAL RECOGNITION IN AUTOMOTIVE SYSTEMS

(71) Applicant: MOTIVE TECHNOLOGIES, INC., San Francisco, CA (US)

(72) Inventors: Simon KAUFMANN, Salt Lake City, UT (US); Saravana Mahesh THANGAVELU, Newark, CA (US); Waqas Ahmed ANSARI, Karachi (PK)

(21) Appl. No.: 19/090,923

(22) Filed: Mar. 26, 2025

(51) Int. Cl. G06V 20/59; B60W 40/08; G06V 40/16; G06V 40/50

(52) U.S. Cl. CPC G06V 20/59; B60W 40/08; G06V 40/167; G06V 40/172; G06V 40/50; B60W 2040/0809; B60W 2420/403; B60W 2520/10; B60W 2540/043; B60W 2540/223; B60W 2556/20

(57) ABSTRACT

The techniques described herein relate to a system including: a vehicle environment that includes a camera on a windshield of a vehicle and a processor in the vehicle, the vehicle environment configured to: determine that a vehicle speed value of the vehicle exceeds a first threshold and that a vehicle stop duration exceeds a time threshold, capture a plurality of facial images, and transmit the plurality of facial images; and a cloud platform including one or more computing devices, the computing devices of the cloud platform configured to: receive the plurality of facial images, generate confidence scores for each facial image compared against stored driver profiles, compute based on the confidence scores, a vote count and an average score for a candidate driver profile, and assign a driver identifier to a vehicle based on the vote count and average score exceeding respective thresholds.

### BACKGROUND

Fleet management systems are widely used to track and manage commercial vehicle operations. These systems typically rely on various methods for identifying drivers, such as manual logins, radio frequency identification (RFID) cards, or mobile applications. Further, traditional driver identification methods often require active participation from the driver, such as scanning an identification card (e.g., license) or entering credentials into a mobile device.

Facial recognition technology has been used in various security and authentication contexts. Generally, facial recognition systems capture an image of a person's face and compare it against a database of known faces to determine identity. These systems have been deployed in applications ranging from smartphone unlocking to building access control.

Vehicle fleets face particular challenges in maintaining accurate records of which drivers are operating specific vehicles at any given time. Fleet managers need reliable driver identification to ensure regulatory compliance, maintain security, and track driver performance. Manual identification methods can be prone to errors or manipulation, while automated systems often require additional hardware installation or driver training.

Existing automated driver identification approaches may use various biometric factors such as fingerprints, voice recognition, or facial features. However, these systems typically require the driver to pause and actively participate in the identification process, which can impact operational efficiency.

### BRIEF DESCRIPTION OF THE DRAWINGS

FIG. 1 is a block diagram illustrating a driver identification system according to some of the disclosed embodiments.

FIG. 2 is a flow diagram illustrating a method for capturing driver facial images according to some of the disclosed embodiments.

FIG. 3 is a flow diagram illustrating a method for implementing a voting-based facial recognition algorithm according to some of the disclosed embodiments.

FIG. 4 is a flow diagram illustrating a method for managing driver facial profiles according to some of the disclosed embodiments.

FIG. 5 is a flow diagram illustrating a method for processing driver profile matches and managing driver assignments according to some of the disclosed embodiments.

FIG. 6 is a block diagram of a computing device according to some embodiments of the disclosure.

### DETAILED DESCRIPTION

Real-time facial recognition in vehicular environments presents significant technical challenges due to the dynamic nature of image capture conditions. Specifically, vehicle motion creates continuous variations in lighting conditions and driver (or other vehicle occupant) head positioning, while vehicle stops and starts can generate irregular capture windows. These conditions make it difficult to obtain consistent, high-quality facial images suitable for recognition processing and prevent the use of off-the-shelf facial recognition technology. Additionally, performing facial recognition comparisons against large databases of potential drivers introduces computational overhead that can impact system responsiveness. Finally, the often limited processing power of in-vehicle processors limits the application of larger predictive models. Thus, existing facial recognition systems often fail to achieve reliable matches when processing images captured during active vehicle operation, as these systems typically expect controlled capture conditions with consistent lighting and subject positioning and significant local processing power.

The disclosed technology addresses these technical challenges through a multi-stage capture and recognition pipeline. The system first employs a synchronized combination of vehicle motion sensors and computer vision algorithms to identify optimal capture windows based on specific speed and duration thresholds. A specialized image capture protocol ensures multiple high-quality facial images are obtained during these windows by monitoring head position and implementing strict quality control criteria. This subprocess (described in more detail) addresses a first technical challenge existing technology has in ensuring high quality capture data sufficient to perform facial matching.

The system then employs a novel voting-based recognition algorithm that processes multiple images in parallel, applying adaptive confidence thresholds based on match counts. This approach compensates for variation in individual image quality while maintaining high accuracy. This subprocess (described in more detail) addresses a second technical challenge existing technology has in ensuring that the predicted identity is accurate given potentially anomalous scenarios.

The technology further implements an intelligent profile management system that maintains optimal reference images through automated aging and replacement mechanisms, ensuring the recognition database remains current while constraining computational requirements. In some implementations, this profile management system can also be designed to ensure varied types of images (such as nighttime, bright lighting conditions, different angles, etc.) are maintained for each driver, maximizing the system's ability to match faces across diverse environmental conditions. This subprocess (described in more detail) addresses a third technical challenge existing technology has in ensuring high-quality matching data. Through this technical architecture, the system achieves reliable facial recognition under dynamic vehicular conditions without requiring controlled capture environments or manual intervention in the identification process.

In some implementations, the techniques described herein relate to a system including: a vehicle environment including a vehicle that includes a camera on a windshield of the vehicle and a processor installed within the vehicle, the vehicle environment configured to: determine, by the, that a vehicle speed value of the vehicle exceeds a first threshold and that a vehicle stop duration exceeds a time threshold, capture, by the camera, a plurality of facial images, and transmit, by the processor, the plurality of facial images; and a cloud platform including one or more computing devices, the computing devices of the cloud platform configured to: receive the plurality of facial images, generate confidence scores for each facial image compared against stored driver profiles, compute based on the confidence scores, a vote count and an average score for a candidate driver profile, and assign a driver identifier to a vehicle based on the vote count and average score exceeding respective thresholds.

In some implementations, the techniques described herein relate to a system, further including: monitoring, by the processor, a head position of a vehicle occupant; and determining, by the processor, that the head position remains forward-facing for a minimum duration, wherein capturing the plurality of facial images occurs during the minimum duration.

In some implementations, the techniques described herein relate to a system, wherein computing the vote count at the cloud platform includes: determining a number of facial images matching the candidate driver profile; calculating an average confidence score by summing confidence scores of matching images and dividing by the total number of matching images; classifying the match as high, medium, or low confidence based on the average confidence score; and validating the candidate driver profile when either: the confidence is classified as high or the confidence is classified as medium and the candidate driver profile has been associated with the same vehicle within the past 24 hours.

In some implementations, the techniques described herein relate to a system, further including: maintaining, at the cloud platform, a profile database containing up to a maximum number of facial images per driver; removing oldest facial images from profiles exceeding an age threshold; adding new facial images to profiles below a maximum number; and ensuring a varied profile for strong matching by selectively storing facial images captured under different environmental conditions such as varying lighting, angles, and times of day.

In some implementations, the techniques described herein relate to a system, wherein assigning the driver identifier includes: determining whether the candidate driver profile is a familiar or unfamiliar profile; automatically assigning the driver identifier when the candidate driver profile is familiar and the confidence scores exceed an automatic assignment threshold; and generating an alert for manual assignment when the confidence scores are below the automatic assignment threshold.

In some implementations, the techniques described herein relate to a system, wherein computing the average score includes: applying a first confidence threshold when only one facial image matches the candidate driver profile; and applying a second confidence threshold lower than the first confidence threshold when multiple facial images match the candidate driver profile.

In some implementations, the techniques described herein relate to a system, further including: determining, by the processor, that the plurality of facial images meet quality criteria; monitoring, by the processor, head position and vehicle speed when the quality criteria are not met; and capturing a second plurality of facial images when the head position and vehicle speed indicate suitable capture conditions.

In some implementations, the techniques described herein relate to a method including: determining, by a processor of a vehicle, that a vehicle speed value of the vehicle exceeds a first threshold and that a vehicle stop duration exceeds a time threshold; capturing, by a camera on a windshield of the vehicle, a plurality of facial images; generating, by a cloud platform, confidence scores for each facial image compared against stored driver profiles; computing, at the cloud platform, based on the confidence scores, a vote count and an average score for a candidate driver profile; and assigning, by the cloud platform, a driver identifier to a vehicle based on the vote count and average score exceeding respective thresholds.

In some implementations, the techniques described herein relate to a method, further including: monitoring, by the processor, a head position of a vehicle occupant; and determining that the head position remains forward-facing for a minimum duration, wherein capturing the plurality of facial images occurs during the minimum duration.

In some implementations, the techniques described herein relate to a method, wherein computing the vote count at the cloud platform includes: determining a number of facial images matching the candidate driver profile; calculating an average confidence score by summing confidence scores of matching images and dividing by the total number of matching images; classifying the match as high, medium, or low confidence based on the average confidence score; and validating the candidate driver profile when either: the confidence is classified as high or the confidence is classified as medium and the candidate driver profile has been associated with the same vehicle within the past 24 hours.

In some implementations, the techniques described herein relate to a method, further including: maintaining, at the cloud platform, a profile database containing up to a maximum number of facial images per driver; removing oldest facial images from profiles exceeding an age threshold; and adding new facial images to profiles below a maximum number.

In some implementations, the techniques described herein relate to a method, wherein assigning the driver identifier includes: determining whether the candidate driver profile is a familiar or unfamiliar profile; automatically assigning the driver identifier when the candidate driver profile is familiar and the confidence scores exceed an automatic assignment threshold; and generating an alert for manual assignment when the confidence scores are below the automatic assignment threshold.

In some implementations, the techniques described herein relate to a method, wherein computing the average score includes: applying a first confidence threshold when only one facial image matches the candidate driver profile; and applying a second confidence threshold lower than the first confidence threshold when multiple facial images match the candidate driver profile.

In some implementations, the techniques described herein relate to a method, further including: determining, by the processor, that the plurality of facial images meet quality criteria; monitoring, by the processor, head position and vehicle speed when the quality criteria are not met; and capturing a second plurality of facial images when the head position and vehicle speed indicate suitable capture conditions.

In some implementations, the techniques described herein relate to a non-transitory computer-readable storage medium for tangibly storing computer program instructions capable of being executed by a computer processor, the computer program instructions defining steps of: determining, by a processor of a vehicle, that a vehicle speed value of the vehicle exceeds a first threshold and that a vehicle stop duration exceeds a time threshold; capturing, by a camera on a windshield of the vehicle, a plurality of facial images; generating, by a cloud platform, confidence scores for each facial image compared against stored driver profiles; computing, at the cloud platform, based on the confidence scores, a vote count and an average score for a candidate driver profile; and assigning, by the cloud platform, a driver identifier to a vehicle based on the vote count and average score exceeding respective thresholds.

In some implementations, the techniques described herein relate to a non-transitory computer-readable storage medium, the steps further including: monitoring, by the processor, a head position of a vehicle occupant; and determining that the head position remains forward-facing for a minimum duration, wherein capturing the plurality of facial images occurs during the minimum duration.

In some implementations, the techniques described herein relate to a non-transitory computer-readable storage medium, wherein computing the vote count at the cloud platform includes: determining a number of facial images matching the candidate driver profile; calculating an average confidence score by summing confidence scores of matching images and dividing by the total number of matching images; classifying the match as high, medium, or low confidence based on the average confidence score; and validating the candidate driver profile when either: the confidence is classified as high or the confidence is classified as medium and the candidate driver profile has been associated with the same vehicle within the past 24 hours.

In some implementations, the techniques described herein relate to a non-transitory computer-readable storage medium, the steps further including: maintaining, at the cloud platform, a profile database containing up to a maximum number of facial images per driver; removing oldest facial images from profiles exceeding an age threshold; and adding new facial images to profiles below a maximum number.

In some implementations, the techniques described herein relate to a non-transitory computer-readable storage medium, wherein assigning the driver identifier includes: determining whether the candidate driver profile is a familiar or unfamiliar profile; automatically assigning the driver identifier when the candidate driver profile is familiar and the confidence scores exceed an automatic assignment threshold; and generating an alert for manual assignment when the confidence scores are below the automatic assignment threshold.

In some implementations, the techniques described herein relate to a non-transitory computer-readable storage medium, the steps further including: determining, by the processor, that the plurality of facial images meet quality criteria; monitoring, by the processor, head position and vehicle speed when the quality criteria are not met; and capturing a second plurality of facial images when the head position and vehicle speed indicate suitable capture conditions.

The following description expands on the solution in more detail.

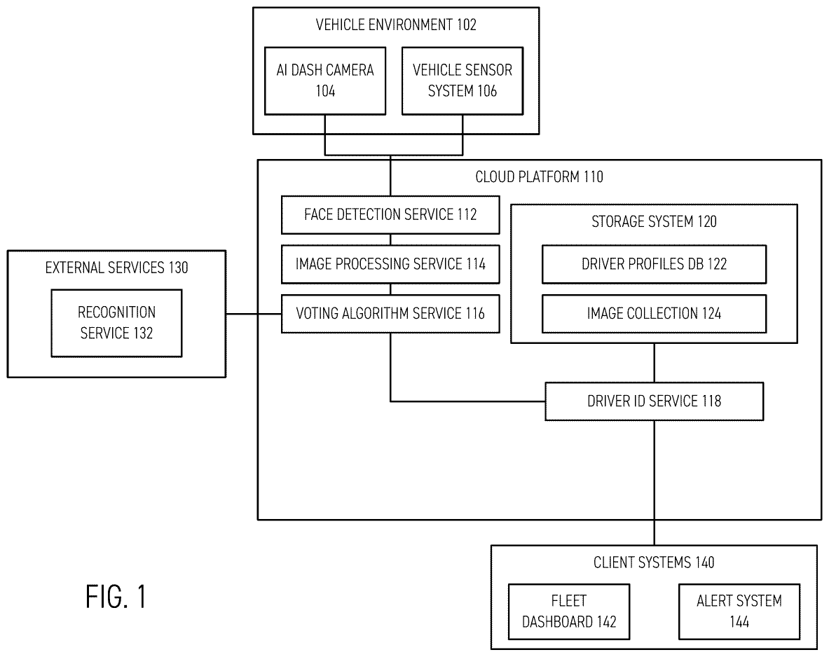

FIG. 1 is a block diagram illustrating a driver identification system according to some of the disclosed embodiments.

In the illustrated embodiment, the system includes several interconnected subsystems including a vehicle environment 102, a cloud platform 110, external services 130, and client systems 140. The various subsystems communicate with each other to enable real-time driver (or other vehicle occupant) identification using facial recognition technology. The system is designed to provide reliable driver identification without requiring manual intervention or additional hardware such as RFID cards or mobile devices, as will be discussed in more detail herein.

Within the vehicle environment 102, a dash camera 104 is communicatively coupled with a vehicle sensor system 106. In some implementations, the dash camera 104 may be mounted on the interior of the vehicle, for example, on the windshield or dashboard, and oriented to capture images of a driver's or passenger's face. The dash camera 104 may include specialized hardware for low-light operation and glare reduction to maintain reliable image capture across varying lighting conditions. In some implementations, the dash camera 104 may also include computer vision models and other machine learning or artificial intelligence models. As one non-limiting example, the dash camera 104 may include a head pose detection model. In some implementations, this head pose detection model can be formed as part of a multi-task predictive model that includes a convolutional network coupled to a feature pyramid network as a backbone model. In this example, the head pose detection may be performed by a separate convolutional model that receives, as inputs, the outputs of the backbone network and outputs a bounding box, orientation, or similar representation of a head pose.

The vehicle sensor system 106 may include various sensors to detect vehicle motion and operational parameters, such as vehicle speed, engine status, and trip duration. In some implementations, the vehicle sensor system 106 may interface directly with the vehicle's onboard diagnostic (OBD) system via a dedicated port to obtain precise measurements of vehicle operation. In some implementations, the vehicle environment 102 may further include a gateway device (not illustrated) to facilitate communication between the dash camera 104 and the vehicle sensor system 106.

The cloud platform 110 includes several interconnected services that process data from the vehicle environment 102. A face detection service 112 receives image data from the dash camera 104 and sensor data from the vehicle sensor system 106. In some implementations, the face detection service 112 analyzes the received data to identify when conditions are suitable for capturing driver facial images, such as when the vehicle is moving above a threshold speed and the driver's head position indicates proper facial visibility (i.e., forward facing). The face detection service 112 may implement filtering algorithms to ensure that only high-quality face detection events are processed further, reducing unnecessary computational load on downstream services.

The image processing service 114 receives detected face images from the face detection service 112 and performs initial processing operations. In some implementations, the image processing service 114 may verify image quality, adjust for lighting conditions, and prepare images for facial recognition analysis. This service may apply various image enhancement techniques such as contrast adjustment, noise reduction, and resolution optimization to ensure the highest possible quality input for facial recognition. The processed images are then provided to a voting algorithm service 116, which coordinates the facial recognition matching process.

The voting algorithm service 116 interfaces with external services 130, such as the recognition service 132 (e.g., which may be implemented via a third-party service such as AWS® Rekognition®), to perform facial recognition comparisons. In some implementations, the voting algorithm service 116 sends multiple images of a detected face to recognition service 132 and receives confidence scores indicating potential matches with known driver profiles. The service implements a voting algorithm that considers not only individual confidence scores but also the consistency of matches across multiple images. In some implementations, the voting algorithm requires a minimum of four images for reliable identification, with specific threshold requirements that vary based on the number of successfully matched images. Certainly, the specific number of images and thresholds are not limiting and may be tuned based on system performance.

A driver ID service 118 receives matching results from the voting algorithm service 116 and manages driver identification assignments. Although drivers are discussed throughout, the system can be applied to any vehicle occupant. The driver ID service 118 interfaces with a storage system 120 that includes a driver profiles database 122 and an image collection 124. In some implementations, the driver profiles database 122 maintains records of known drivers including their identification information and associated facial profiles. Each driver profile may include metadata such as driver license information, employment status, and vehicle assignments. The image collection 124 stores facial images used to create and update these profiles, with each profile potentially containing up to a predetermined number of images that are periodically refreshed to maintain currency. The system implements an image rotation strategy, maintaining (as a non-limiting example) up to fifty images per driver and automatically refreshing the oldest images every sixty days to ensure profiles remain current.

The storage system 120 provides bi-directional communication with the driver ID service 118, allowing for both storage and retrieval of profile information. This enables the driver ID service 118 to create new profiles for previously unknown drivers, update existing profiles with new images, and retrieve profile information when matches are identified. The storage system 120 may implement various optimization techniques, such as caching frequently accessed profiles and maintaining indices for rapid profile lookup based on facial recognition vectors.

Client systems 140 receive driver identification information from the driver ID service 118. These client systems include a fleet dashboard 142 and an alert system 144. In other implementations, additional client systems may be included (e.g., mobile device, API endpoints, etc.). In some implementations, the fleet dashboard 142 provides real-time visibility into driver assignments across a vehicle fleet, with capabilities for filtering, searching, and generating reports on driver activity. The alert system 144 can notify fleet managers of various events such as unidentified drivers or potential security concerns, with configurable notification rules and escalation paths.

The illustrated system enables real-time driver identification through a coordinated pipeline of services, which are described in more detail in connection with the flow diagrams but are described generally herein. When a driver enters a vehicle, the dash camera 104 and vehicle sensor system 106 provide data to initiate the identification process. This data flows through the various cloud platform services, interfacing with external facial recognition capabilities, to quickly and accurately identify the driver. The identification information is then made available to fleet managers and other authorized users through the client systems 140.

In some implementations, the system may operate continuously during vehicle operation, allowing for ongoing verification of driver identity and detection of driver changes during a trip. The system implements state management to track driver changes and maintain accurate trip records, even in cases where multiple drivers might operate the same vehicle during a single day.

The system can also adapt to changes in driver appearance over time through its profile management capabilities, maintaining accurate identification even as drivers'appearances naturally change. This adaptability is achieved through the continuous update of driver profiles with new images, coupled with the periodic removal of older images that might no longer accurately represent the driver's current appearance.

The architecture illustrated in FIG. 1 provides a scalable and reliable approach to driver identification that can be deployed across large vehicle fleets while maintaining consistent performance and accuracy. The separation of concerns between different services enables efficient processing and allows for independent scaling of different system components as needed to handle increasing workloads. The system's modular design also facilitates future enhancements, such as the integration of additional biometric factors or the implementation of advanced security features.

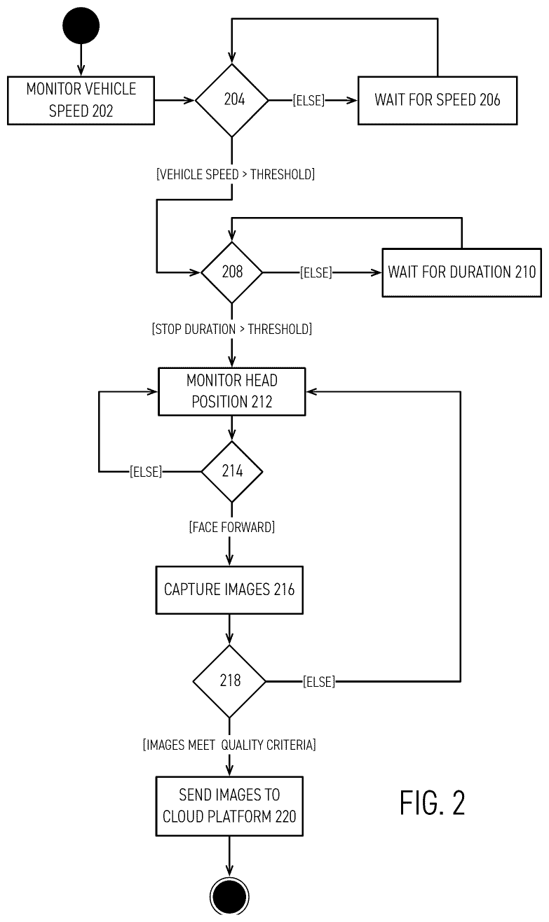

FIG. 2 is a flow diagram illustrating a method for capturing driver facial images according to some of the disclosed embodiments.

In step 202, the method includes monitoring vehicle speed. In some implementations, a vehicle sensor system continuously measures the current speed of a vehicle through integration with the vehicle's onboard diagnostics system or through independent speed sensing mechanisms (e.g., GPS-based). The speed monitoring ensures that facial capture attempts are only initiated when the vehicle is in active operation, reducing unnecessary processing and ensuring more reliable capture conditions.

In step 204, the method determines whether the vehicle speed exceeds a predetermined threshold. In some implementations, this threshold can be set to five miles per hour (as a non-limiting example) to ensure the vehicle is in genuine motion rather than merely idling or performing minor movements. This speed threshold serves multiple purposes. First, it helps confirm that the vehicle is actively being operated. Second, it reduces false triggers during parking or maintenance activities. Third, it ensures more stable lighting conditions for image capture as the vehicle is typically oriented forward during active driving. Fourth, it can increase the likelihood that the driver is looking forward and maintaining proper driving posture, which creates optimal conditions for capturing high-quality facial images suitable for recognition. The combination of vehicle motion and driver attention to the road ahead provides a natural opportunity for unobtrusive facial image capture.

If the speed threshold is not met, the method proceeds to step 206, where it enters a wait state while continuing to monitor vehicle speed. In some implementations, this waiting period may include a small delay between speed checks to optimize system resources. The method continues to loop through steps 204 and 206 until the speed threshold is exceeded.

Once the speed threshold is exceeded, the method proceeds to step 208, where it evaluates the duration since the last vehicle stop. In some implementations, the method maintains a timer that tracks the duration since the vehicle's last complete stop. This step helps distinguish between genuine new trips and brief stops during an ongoing trip, such as at traffic signals or in stop-and-go traffic.

The method determines whether the stop duration exceeds a predetermined threshold, which in some implementations can be set to six minutes (as a non-limiting example). This duration threshold can be selected based on analysis of typical driver behavior patterns, where stops longer than x minutes generally indicate a genuine trip conclusion rather than a temporary traffic stop. If the stop duration threshold is not met, the method proceeds to step 210, where it continues to monitor the duration while waiting for the threshold to be met.

Once both the speed and stop duration criteria are satisfied, the method proceeds to step 212, where it begins monitoring the driver's head position. In some implementations, this monitoring is performed using computer vision models (described in FIG. 1) that analyze the video/image feed from the dash camera to determine if the occupant's head is, for example, sufficiently forward-facing. The head position monitoring specifically looks for proper alignment (e.g., forward facing) that would enable clear capture of the driver's facial features. In addition to head position, the method can perform quality checks including verifying face pose confidence levels for specific orientations (looking down, left, and right); ensuring facial bounding box size exceeds a minimum threshold to prioritize larger or nearer-to-camera faces; and continuously confirming the vehicle maintains movement above the speed threshold during the image capture process. These multi-dimensional quality checks work in concert to ensure that only optimal facial images proceed to the recognition phase, thereby improving matching accuracy.

In step 214, the method evaluates whether the driver's face is oriented forward in a position suitable for image capture (e.g., forward-facing). In some implementations, this evaluation considers multiple factors including the angle of the head relative to the camera, the visibility of key facial features, and the stability of the head position. The method specifically looks for the driver's face to be oriented forward for a minimum duration, which in some implementations is set to four seconds within a ten second window (as a non-limiting example). This duration requirement helps ensure that the captured images will be of sufficient quality for facial recognition processing.

If the face is not properly positioned, the method returns to step 212 to continue monitoring. This creates a loop that continuously evaluates head position until suitable conditions (i.e., forward facing) are detected. In some implementations, this loop may include brief waiting periods between checks to optimize system resources while still maintaining responsive monitoring.

When proper facial positioning is detected, the method proceeds to step 216, where it captures a series of images. In some implementations, the system captures four distinct images (as a non-limiting example) within a short time window. The use of multiple images serves several purposes: it provides redundancy in case some images are of lower quality, enables voting-based confidence algorithms in the facial recognition phase, and helps account for minor variations in expression or position that might occur during capture.

In step 218, the method evaluates whether the captured images meet predetermined quality criteria. In some implementations, these criteria may include minimum resolution requirements, proper focus, adequate lighting, and confirmation that key facial features are clearly visible. The quality evaluation helps ensure that only images suitable for accurate facial recognition processing are transmitted to the cloud platform.

If the images fail to meet the quality criteria, the method returns to step 212 to resume monitoring head position and attempt another capture. This creates a feedback loop that continues until suitable images are obtained. In some implementations, this loop may include logic to prevent excessive rapid retries, such as implementing a brief cooling-off period between capture attempts.

When images of sufficient quality are obtained, the method proceeds to step 220, where it transmits the captured images to the cloud platform for further processing. In some implementations, this transmission includes not only the facial images themselves but also associated metadata such as timestamp, vehicle identifier, and relevant sensor data that might assist in the identification process.

The transmission step may employ various optimization techniques to ensure reliable delivery while managing bandwidth usage. In some implementations, the images may be compressed using lossy or lossless compression algorithms depending on the available network bandwidth and required image quality. The system may also implement retry logic with exponential backoff in case of transmission failures, ensuring that captured images are eventually delivered to the cloud platform even in conditions of intermittent connectivity.

The method illustrated in FIG. 2 represents an orchestrated sequence of checks and balances designed to capture high-quality facial images under real-world driving conditions. By implementing multiple validation steps—from vehicle motion verification through image quality confirmation—the method helps ensure that downstream facial recognition processes receive optimal input data. This methodical approach helps maintain high accuracy in driver (or other vehicle occupant) identification while minimizing system resource usage and network bandwidth consumption.

The various thresholds and timing parameters used throughout the method can be calibrated based on real-world usage data and specific deployment requirements. For example, the speed threshold, stop duration, and face positioning duration could be adjusted to balance between capture reliability and system responsiveness. Similarly, the image quality criteria could be tuned based on the specific requirements of the facial recognition algorithms being used.

This systematic approach to image capture provides a foundation for reliable driver identification while accounting for the practical challenges of operating in dynamic vehicular environments. The method's validation steps and feedback loops help ensure consistent performance across varying conditions while maintaining efficient use of system resources.

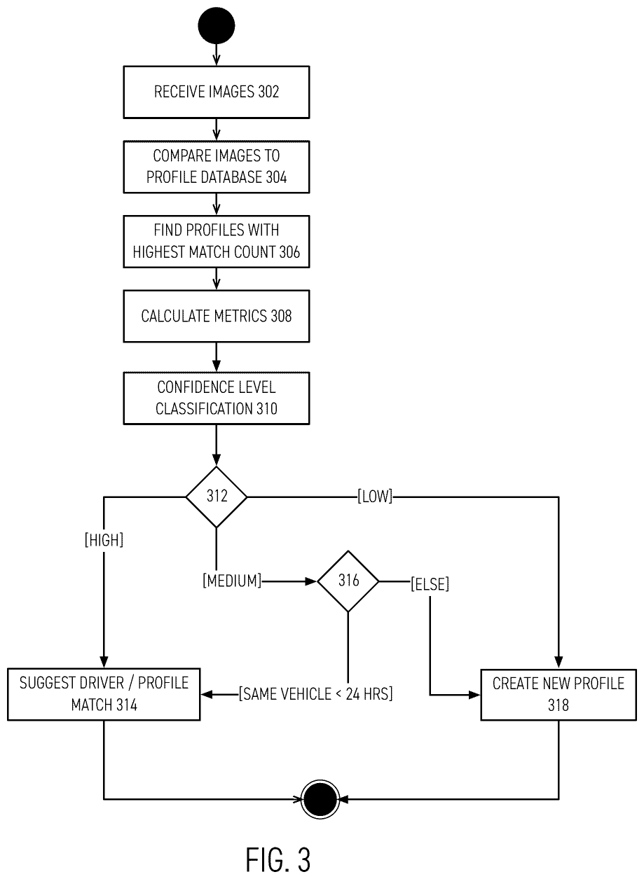

FIG. 3 is a flow diagram illustrating a method for implementing a voting-based facial recognition algorithm according to some of the disclosed embodiments.

In step 302, the method includes receiving a set of facial images for processing. In some implementations, these images are received from the vehicle environment following the capture process detailed in FIG. 2. The method typically receives four distinct images of the driver's face (although the exact number is not limiting), all captured within a predefined time window during active vehicle operation. In some implementations, each received image is accompanied by metadata including capture timestamp, image quality metrics, and vehicle identifier information. The use of multiple images enables a more robust matching process through the voting mechanism described in subsequent steps.

In step 304, the method compares each received image against a database of known driver profiles. In some implementations, this comparison is performed using a recognition service, which generates similarity scores between the input images and previously stored profile images. Each comparison yields a confidence score indicating the likelihood that the input image matches a particular profile. In some implementations, the comparison process may be optimized by first filtering the profile database based on relevant criteria such as fleet assignment or geographic region, reducing the number of required comparisons while maintaining accuracy.

The method then proceeds to step 306, where it identifies the profile with the highest number of matching images across the input set. In some implementations, this step involves grouping the comparison results by profile and counting how many of the input images yielded high confidence matches for each profile. For example, if three out of four input images strongly match Profile A, while only one image matches Profile B, then Profile A would be identified as the profile with the highest match count. This approach helps mitigate the impact of any single aberrant image or comparison result. Additionally, in some implementations, the method can include comparing the vehicle the driver is currently operating with historical vehicle usage patterns associated with candidate profiles. This comparison may allow the method to adjust confidence thresholds, enabling successful matching with lower confidence images when consistent with established usage patterns. For instance, if a driver has historically operated a specific vehicle during certain time periods or along particular routes, this information can strengthen an otherwise borderline facial recognition match.

In step 308, the method calculates several key metrics that will be used to validate the potential match. These metrics can include a vote count which represents the total number of images that match the candidate profile above a base confidence threshold. The metrics can further include an average score which is the mean confidence score across all matching images for the candidate profile. The metrics can further include a vote percentage which is the proportion of total input images that match the candidate profile, expressed as a percentage

In some implementations, these metrics are weighted differently depending on the total number of valid input images available. For example, if only two of the four input images were of sufficient quality for comparison, the vote percentage threshold might be adjusted to account for the reduced sample size.

The method then enters a confidence level classification stage in step 310, where it categorizes the candidate profile based on the calculated metrics. In this step, the average score is calculated for the suggested profile using the formula: average score =sum of confidence scores/total votes. Based on this average score, the method classifies the match confidence as either HIGH, MEDIUM, or LOW.

In step 312, the method evaluates the confidence level classification. If the confidence is classified as HIGH, the method proceeds directly to step 314, where it suggests the candidate profile as a match for the input images. This immediate suggestion for high confidence matches helps streamline the identification process for clearly matching profiles.

If the confidence is classified as MEDIUM, the method proceeds to step 316, where it performs a vehicle history check to determine if the matched profile has been associated with the same vehicle within the last 24 hours. This additional contextual verification helps validate borderline matches by leveraging historical usage patterns. If the system confirms that the candidate profile has used the same vehicle within the specified time window, it proceeds to step 314 to suggest the profile as a match. If the vehicle history check does not confirm recent usage, the method instead proceeds to step 318, where it creates a new profile for the face. If the confidence is classified as LOW in step 312, the method proceeds directly to step 318, where it creates a new profile for the face. This approach ensures that low-confidence matches do not result in potential misidentifications while still capturing the facial data for future reference and potential manual review.

The confidence level classification approach provides a more adaptive and context-aware method for determining matches. For MEDIUM confidence matches, the vehicle history check in step 316 serves as a critical validation mechanism. By verifying whether the candidate profile has operated the same vehicle within the past 24 hours, the system can leverage operational patterns to make more informed decisions about borderline matches. This approach balances accuracy requirements with practical operational considerations in fleet management scenarios.

When a candidate profile is classified with LOW confidence, the method proceeds to step 318, creating a new profile for the face. This approach differs from simply recording no match, as it actively captures the facial data in a new profile for future reference. This strategy helps build a more comprehensive driver database over time while avoiding potential misidentifications from low-confidence matches that could have significant operational implications in a fleet management context.

If either the confidence level is HIGH or it is MEDIUM with confirmed recent vehicle usage, the method proceeds to step 314, where it suggests the candidate profile as a match for the input images. In some implementations, this suggestion includes not only the profile identifier but also the calculated metrics that led to the match decision. This detailed output enables downstream processes to make informed decisions about how to handle the identification, potentially applying additional business rules or verification steps before finalizing the driver assignment.

The voting-based approach illustrated in FIG. 3 represents an improved method for facial recognition that balances accuracy with practical operational requirements. By implementing varying thresholds based on the number of matching images and considering multiple images, the method helps minimize both false positive and false negative results. The use of varying thresholds based on the number of matching images provides flexibility while maintaining strict accuracy requirements.

The method is particularly well-suited to the challenges of driver identification in fleet operations, where both accuracy and speed are important. The adaptive thresholding approach help ensure reliable identification while the parallel processing of multiple images helps maintain reasonable processing times. The method's design also accommodates real-world variations in image quality and capture conditions through its adaptive thresholding approach.

In some implementations, the method may include additional optimization steps not explicitly shown in the diagram. For example, the comparison process might implement caching mechanisms to store recent comparison results, reducing processing time for frequently seen drivers. Similarly, the method might implement early exit conditions, where exceptionally strong matches can bypass some validation steps.

The method can also be tuned based on specific operational requirements by adjusting the confidence classification and validation criteria. For example, applications requiring extremely high security might implement higher confidence score thresholds, while those prioritizing user convenience might slightly relax the vehicle history check. This flexibility enables the method to be adapted to various use cases while maintaining its fundamental voting-based approach to facial recognition.

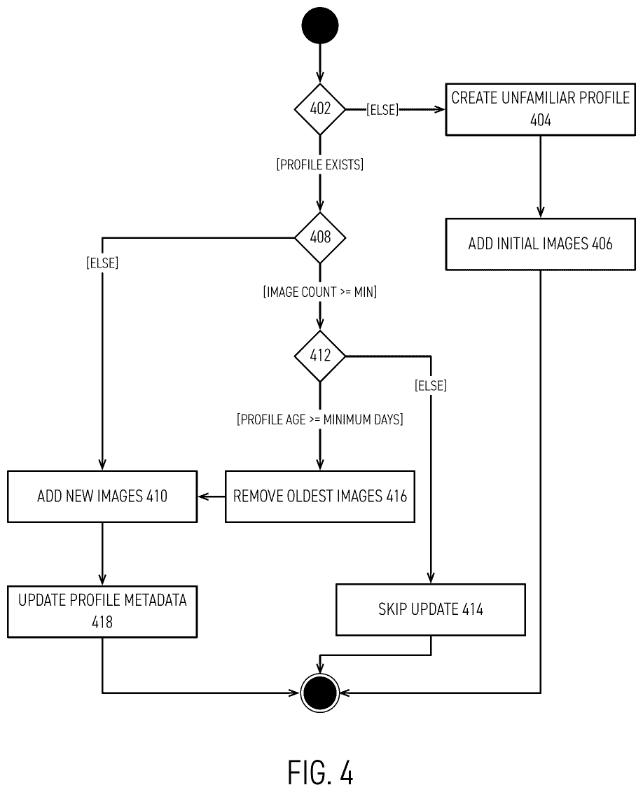

FIG. 4 is a flow diagram illustrating a method for managing driver facial profiles according to some of the disclosed embodiments.

In step 402, the method evaluates whether a profile exists for a given driver (or other vehicle occupant). In some implementations, this check occurs after receiving a set of facial images and associated metadata from the voting algorithm described in FIG. 3. The profile existence check may involve querying both the driver profiles database and the recognition service collection to ensure consistency between local and cloud-based profile storage. In some implementations, this step may also verify the profile's status (e.g., active, suspended, or archived) to ensure only valid profiles are considered for updates.

If no profile exists, the method proceeds to step 404, where it creates an unfamiliar profile. In some implementations, an unfamiliar profile serves as a temporary container for facial images that have been captured but not yet associated with a known driver. Each unfamiliar profile is assigned a unique identifier and maintains its own set of metadata, including the timestamp of creation, the vehicle from which the images were captured, and any relevant operational context. The creation of unfamiliar profiles enables the system to track and manage unidentified drivers while maintaining the ability to retroactively associate them with known drivers once proper identification is made.

Following the creation of an unfamiliar profile, the method proceeds to step 406, where it adds the initial set of facial images to the profile. In some implementations, this involves both storing the images in the local image collection and indexing them in the recognition service. The initial images serve as the foundation for future matching attempts and are typically the highest-quality images available from the capture session. The method may implement specific quality thresholds for initial images to ensure the profile begins with optimal reference data.

If a profile does exist, the method proceeds to step 408, where it checks whether the profile's current image count meets or exceeds a minimum threshold. In some implementations, this minimum threshold is significantly lower than the maximum allowed images (e.g., requiring at least five images before considering removal of old images). This check helps ensure that profiles maintain enough reference images for reliable matching while still allowing for periodic updates to account for changes in appearance.

When the image count is below the minimum threshold, the method proceeds directly to step 410, where it adds new images to the profile. In some implementations, the addition of new images follows a specific protocol that includes quality verification, redundancy checking to avoid duplicate or near-duplicate images, and proper indexing in both local and cloud storage. The method may also implement rate limiting to prevent too many images from being added to a profile within a short time period.

If the image count equals or exceeds the minimum threshold, the method proceeds to step 412, where it evaluates the age of the profile's existing images. In some implementations, this evaluation focuses on the oldest images in the profile, checking whether they have been stored for longer than a predetermined duration, for example, sixty days (a non-limiting example). This age check helps ensure that profiles remain current while preventing excessive churn in the reference image set.

When the profile age does not meet the minimum duration threshold, the method proceeds to step 414, where it skips the update process. This skip condition helps maintain profile stability by preventing too-frequent updates to the reference image set. In some implementations, the skip step may include logging the attempted update and the reason for skipping to assist in system monitoring and optimization.

If the profile age meets or exceeds the minimum duration, the method proceeds to step 416, where it removes the oldest images from the profile. In some implementations, this removal process targets the fifteen oldest images (a non-limiting example) in the profile, helping maintain a rolling window of reference images that adapts to gradual changes in the driver's appearance. The removal process includes cleaning up both local storage and cloud-based facial recognition indices to maintain system consistency.

Following either the removal of old images or when adding images to a profile below the minimum threshold, the method proceeds to step 410, where it adds new images to the profile. In some implementations, this addition process includes quality checks, deduplication, and proper indexing of the images across all relevant storage systems. The method may also implement selection criteria to ensure that new images provide meaningful variety in terms of lighting conditions, facial angles, and other relevant factors.

The method concludes at step 418, where it updates the profile metadata to reflect the changes made. In some implementations, this metadata update can include a timestamp of the last modification, a current image count, quality metrics for the profile's image set, historical data about image additions and removals, usage statistics for the profile, performance metrics such as successful match rates, or any permutation thereof.

The profile management method illustrated in FIG. 4 represents an approach to maintaining facial recognition profiles that balance accuracy, freshness, and system resource utilization. The method's careful handling of image addition and removal helps ensure that profiles remain effective for identification while adapting to changes in driver appearance over time.

The various thresholds and timing parameters used throughout the method can be tuned based on operational requirements and empirical performance data. For example, the minimum image count, profile age threshold, and number of images to remove can all be adjusted to optimize the trade-off between profile freshness and stability. Similarly, the quality criteria for new images can be calibrated based on the specific requirements of the facial recognition algorithms being used.

In some implementations, the method may include additional optimizations not explicitly shown in the diagram. For example, the system might implement parallel processing for image addition and removal operations or employ caching mechanisms to improve performance when dealing with frequently accessed profiles. The method might also implement backup procedures to ensure profile data integrity across system components. Additionally, beyond the automated profile creation process for unfamiliar drivers, the method can support manual profile creation by authorized users. This feature allows fleet administrators to proactively create driver profiles rather than waiting for the system to generate unfamiliar profiles through the automated capture process. Through an administrative interface, users can input driver information, upload reference facial images, and establish a verified profile that is immediately available for matching.

The method's systematic approach to profile management provides a foundation for reliable driver identification while accounting for the practical challenges of maintaining accurate facial recognition profiles over time. The careful balance of profile updates helps ensure consistent performance while maintaining efficient use of system resources and storage capacity.

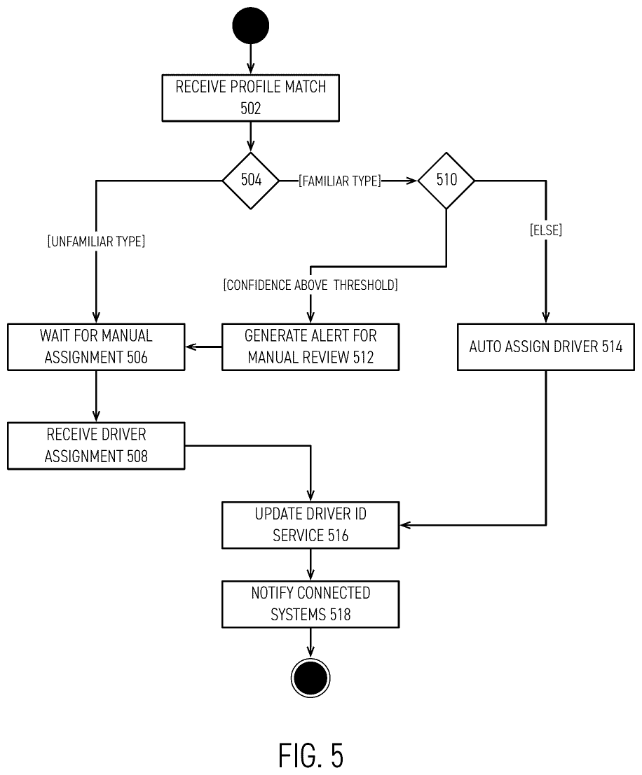

FIG. 5 is a flow diagram illustrating a method for processing driver profile matches and managing driver assignments according to some of the disclosed embodiments.

In step 502, the method begins by receiving a profile match result from the voting algorithm described in FIG. 3. In some implementations, this result includes not only the matched profile identifier but also detailed matching metrics such as confidence scores, vote counts, and match percentages. The received data may also include contextual information about the capture event, such as vehicle identifier, timestamp, and relevant trip data. This comprehensive input enables the method to make informed decisions about how to handle the match.

In step 504, the method evaluates the type of profile that was matched. In some implementations, profiles are categorized into two main types: familiar profiles, which are associated with known drivers, and unfamiliar profiles, which represent faces that have been detected but not yet associated with a specific driver. This distinction enables different handling paths based on the profile's status in the system.

When an unfamiliar profile is identified, the method proceeds to step 506, where it enters a waiting state pending manual driver assignment. In some implementations, this waiting state triggers the creation of a task in the fleet management system, alerting relevant personnel that driver identification is needed. The system may implement queuing mechanisms to manage multiple pending assignments, with prioritization based on factors such as fleet operational requirements or compliance deadlines.

While waiting for manual assignment, the method proceeds to step 508 upon receiving a driver assignment from an authorized user. In some implementations, this assignment includes validation checks to ensure the assigned driver is eligible for the vehicle and fleet in question. The assignment process may also include the collection of additional driver information needed to complete the profile, such as license information or employment status.

If the matched profile is familiar rather than unfamiliar, the method proceeds to step 510, where it evaluates whether the match confidence meets automatic assignment thresholds. In some implementations, these thresholds may be more stringent than the basic matching thresholds used by the voting algorithm, providing an additional layer of verification before automated assignment occurs. The confidence evaluation considers multiple factors including the overall match confidence score, historical matching performance for the profile, contextual factors such as time of day or vehicle assignment patterns, and any recent profile updates or modifications.

If the confidence thresholds are not met, the method proceeds to step 512, where it generates an alert for manual review. In some implementations, these alerts include detailed information about why the automatic assignment threshold was not met, helping reviewers focus their attention on the most relevant aspects of the match. The alerts are prioritized based on operational impact and urgency, ensuring that more pressing identification needs are addressed promptly.

When confidence thresholds are met, the method proceeds to step 514, where it automatically assigns the driver to the vehicle. In some implementations, this automatic assignment includes various validation checks such as verifying driver eligibility and status, checking for scheduling conflicts, validating compliance requirements, confirming vehicle authorization, and checking for any active alerts or restrictions.

Following either manual or automatic driver assignment, the method proceeds to step 516, where it updates the driver ID service. In some implementations, this update operation includes recording the assignment details and history, logging relevant metrics and timestamps, updating related system states, recording validation results, and maintaining compliance tracking information. The driver ID service update ensures that all system components have access to current and accurate driver assignment information. The update process includes transaction management to maintain data consistency across distributed system components.

Finally, in step 518, the method notifies connected systems about the driver assignment. In some implementations, these notifications flow to real-time fleet management dashboards, supervisory personnel, compliance monitoring systems, routing and dispatch systems, driver performance tracking systems, and mobile applications or in-vehicle displays. Safety event notifications can link specific driving incidents (such as hard braking, rapid acceleration, or collision events) with positively identified drivers, enabling accurate attribution of safety-related behaviors. The notification process ensures that all stakeholders and systems have timely access to driver assignment information, with customization based on recipient type and operational requirements.

The method illustrated in FIG. 5 represents a comprehensive approach to managing driver assignments that balances automation with appropriate human oversight. By implementing different paths for familiar and unfamiliar profiles, and including confidence-based automation decisions, the method provides flexibility while maintaining control over the assignment process.

The various thresholds and validation criteria used throughout the method can be tuned based on operational requirements and risk tolerance. For example, automatic assignment thresholds might be adjusted based on historical performance data or specific compliance requirements. Similarly, notification rules and priorities can be customized to match fleet operational patterns and management preferences.

In some implementations, the method may include additional optimizations not explicitly shown in the diagram. The system might implement caching mechanisms for frequently accessed driver information or employ predictive assignment algorithms based on historical patterns. The method might also include fallback procedures for handling edge cases or system disruptions.

The systematic approach to driver assignment management helps ensure reliable and accurate driver tracking while accommodating both automated and manual workflows. The method's careful balance of automation and human oversight provides a foundation for efficient fleet operations while maintaining necessary controls and compliance capabilities.

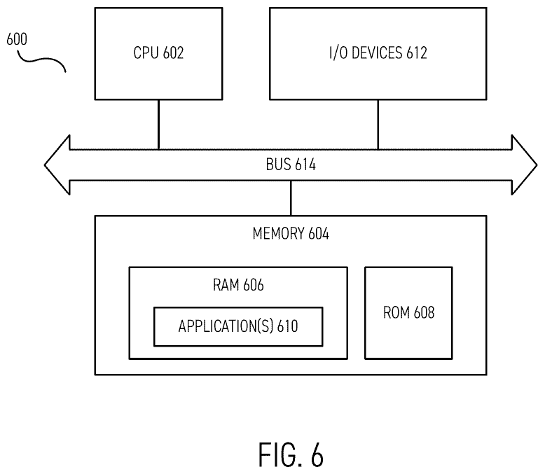

FIG. 6 is a block diagram of a computing device according to some embodiments of the disclosure.

As illustrated, the device 600 includes a processor or central processing unit (CPU) such as CPU 602 in communication with a memory 604 via a bus 614. The device also includes one or more input/output (I/O) or peripheral devices 612. Examples of peripheral devices include, but are not limited to, network interfaces, audio interfaces, display devices, keypads, mice, keyboard, touch screens, illuminators, haptic interfaces, global positioning system (GPS) receivers, cameras, or other optical, thermal, or electromagnetic sensors.

In some embodiments, the CPU 602 may comprise a general-purpose CPU. The CPU 602 may comprise a single-core or multiple-core CPU. The CPU 602 may comprise a system-on-a-chip (SoC) or a similar embedded system. In some embodiments, a graphics processing unit (GPU) may be used in place of, or in combination with, a CPU 602. Memory 604 may comprise a memory system including a dynamic random-access memory (DRAM), static random-access memory (SRAM), Flash (e.g., NAND Flash), or combinations thereof. In one embodiment, the bus 614 may comprise a Peripheral Component Interconnect Express (PCIe) bus. In some embodiments, the bus 614 may comprise multiple busses instead of a single bus.

Memory 604 illustrates an example of a non-transitory computer storage media for the storage of information such as computer-readable instructions, data structures, program modules, or other data. Memory 604 can store a basic input/output system (BIOS) in read-only memory (ROM), such as ROM 608 for controlling the low-level operation of the device. The memory can also store an operating system in random-access memory (RAM) for controlling the operation of the device.

Applications 610 may include computer-executable instructions which, when executed by the device, perform any of the methods (or portions of the methods) described previously in the description of the preceding figures. In some embodiments, the software or programs implementing the method embodiments can be read from a hard disk drive (not illustrated) and temporarily stored in RAM 606 by CPU 602. CPU 602 may then read the software or data from RAM 606, process them, and store them in RAM 606 again.

The device may optionally communicate with a base station (not shown) or directly with another computing device. One or more network interfaces in peripheral devices 612 are sometimes referred to as a transceiver, transceiving device, or network interface card (NIC).

An audio interface in peripheral devices 612 produces and receives audio signals such as the sound of a human voice. For example, an audio interface may be coupled to a speaker and microphone (not shown) to enable telecommunication with others or generate an audio acknowledgment for some action. Displays in peripheral devices 612 may comprise liquid crystal display (LCD), gas plasma, light-emitting diode (LED), or any other type of display device used with a computing device. A display may also include a touch-sensitive screen arranged to receive input from an object such as a stylus or a digit from a human hand.

A keypad in peripheral devices 612 may comprise any input device arranged to receive input from a user. An illuminator in peripheral devices 612 may provide a status indication or provide light. The device can also comprise an input/output interface in peripheral devices 612 for communication with external devices, using communication technologies, such as USB, infrared, Bluetooth®, or the like. A haptic interface in peripheral devices 612 provides tactile feedback to a user of the client device.

A GPS receiver in peripheral devices 612 can determine the physical coordinates of the device on the surface of the Earth, which typically outputs a location as latitude and longitude values. A GPS receiver can also employ other geo-positioning mechanisms, including, but not limited to, triangulation, assisted GPS (AGPS), E-OTD, CI, SAI, ETA, BSS, or the like, to further determine the physical location of the device on the surface of the Earth. In one embodiment, however, the device may communicate through other components, providing other information that may be employed to determine the physical location of the device, including, for example, a media access control (MAC) address, Internet Protocol (IP) address, or the like.

The device may include more or fewer components than those shown, depending on the deployment or usage of the device. For example, a server computing device, such as a rack-mounted server, may not include audio interfaces, displays, keypads, illuminators, haptic interfaces, Global Positioning System (GPS) receivers, or cameras/sensors. Some devices may include additional components not shown, such as graphics processing unit (GPU) devices, cryptographic co-processors, artificial intelligence (AI) accelerators, or other peripheral devices.

The subject matter disclosed above may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The preceding detailed description is, therefore, not intended to be taken in a limiting sense.

Throughout the specification and claims, terms may have nuanced meanings suggested or implied in context beyond an explicitly stated meaning. Likewise, the phrase “in an embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and,” “or,” or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures, or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The present disclosure is described with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, application-specific integrated circuit (ASIC), or other programmable data processing apparatus, such that the instructions, which execute via the processor of the computer or other programmable data processing apparatus, implement the functions/acts specified in the block diagrams or operational block or blocks. In some alternate implementations, the functions or acts noted in the blocks can occur out of the order noted in the operational illustrations. For example, two blocks shown in succession can in fact be executed substantially concurrently or the blocks can sometimes be executed in the reverse order, depending upon the functionality or acts involved.

We claim:

1. A system comprising:
a vehicle environment comprising a vehicle that includes a camera on a windshield of the vehicle and a processor installed within the vehicle, the vehicle environment configured to:
determine, by the processor, that a vehicle speed value of the vehicle exceeds a first threshold and that a vehicle stop duration exceeds a time threshold,
capture, by the camera, a plurality of facial images, and
transmit, by the processor, the plurality of facial images; and
a cloud platform comprising one or more computing devices, the one or more computing devices of the cloud platform configured to:
receive the plurality of facial images,
generate confidence scores for each facial image compared against stored driver profiles,
compute based on the confidence scores, a vote count and an average score for a candidate driver profile, and
assign a driver identifier to a vehicle based on the vote count and average score exceeding respective thresholds.

2. The system of claim 1, further comprising:
monitoring, by the processor, a head position of a vehicle occupant; and
determining, by the processor, that the head position remains forward-facing for a minimum duration, wherein capturing the plurality of facial images occurs during the minimum duration.

3. The system of claim 1, wherein computing the vote count at the cloud platform comprises:
determining a number of facial images matching the candidate driver profile;
calculating an average confidence score by summing confidence scores of matching images and dividing by the total number of matching images;
classifying the match as high, medium, or low confidence based on the average confidence score; and
validating the candidate driver profile when either: the confidence is classified as high or the confidence is classified as medium and the candidate driver profile has been associated with the same vehicle within the past 24 hours.

4. The system of claim 1, further comprising:
maintaining, at the cloud platform, a profile database containing up to a maximum number of facial images per driver;
removing oldest facial images from profiles exceeding an age threshold; and
adding new facial images to profiles below a maximum number.

5. The system of claim 1, wherein assigning the driver identifier comprises:
determining whether the candidate driver profile is a familiar or unfamiliar profile;
automatically assigning the driver identifier when the candidate driver profile is familiar and the confidence scores exceed an automatic assignment threshold; and
generating an alert for manual assignment when the confidence scores are below the automatic assignment threshold.

6. The system of claim 1, wherein computing the average score comprises:
applying a first confidence threshold when only one facial image matches the candidate driver profile; and
applying a second confidence threshold lower than the first confidence threshold when multiple facial images match the candidate driver profile.

7. The system of claim 1, further comprising:
determining, by the processor, that the plurality of facial images meet quality criteria;
monitoring, by the processor, head position and vehicle speed when the quality criteria are not met; and
capturing a second plurality of facial images when the head position and vehicle speed indicate suitable capture conditions.

8. A method comprising:
determining, by a processor of a vehicle, that a vehicle speed value of the vehicle exceeds a first threshold and that a vehicle stop duration exceeds a time threshold;
capturing, by a camera on a windshield of the vehicle, a plurality of facial images;
generating, by a cloud platform, confidence scores for each facial image compared against stored driver profiles;
computing, at the cloud platform, based on the confidence scores, a vote count and an average score for a candidate driver profile; and
assigning, by the cloud platform, a driver identifier to a vehicle based on the vote count and average score exceeding respective thresholds.

9. The method of claim 8, further comprising:
monitoring, by the processor, a head position of a vehicle occupant; and
determining that the head position remains forward-facing for a minimum duration, wherein capturing the plurality of facial images occurs during the minimum duration.

10. The method of claim 8, wherein computing the vote count at the cloud platform comprises:
determining a number of facial images matching the candidate driver profile;
calculating an average confidence score by summing confidence scores of matching images and dividing by the total number of matching images;
classifying the match as high, medium, or low confidence based on the average confidence score; and
validating the candidate driver profile when either: the confidence is classified as high or the confidence is classified as medium and the candidate driver profile has been associated with the same vehicle within the past 24 hours.

11. The method of claim 8, further comprising:
maintaining, at the cloud platform, a profile database containing up to a maximum number of facial images per driver;
removing oldest facial images from profiles exceeding an age threshold; and
adding new facial images to profiles below a maximum number.

12. The method of claim 8, wherein assigning the driver identifier comprises:
determining whether the candidate driver profile is a familiar or unfamiliar profile;
automatically assigning the driver identifier when the candidate driver profile is familiar and the confidence scores exceed an automatic assignment threshold; and
generating an alert for manual assignment when the confidence scores are below the automatic assignment threshold.

13. The method of claim 8, wherein computing the average score comprises:
applying a first confidence threshold when only one facial image matches the candidate driver profile; and
applying a second confidence threshold lower than the first confidence threshold when multiple facial images match the candidate driver profile.

14. The method of claim 8, further comprising:
determining, by the processor, that the plurality of facial images meet quality criteria;
monitoring, by the processor, head position and vehicle speed when the quality criteria are not met; and
capturing a second plurality of facial images when the head position and vehicle speed indicate suitable capture conditions.

15. A non-transitory computer-readable storage medium for tangibly storing computer program instructions capable of being executed by a computer processor, the computer program instructions defining steps of:
determining, by a processor of a vehicle, that a vehicle speed value of the vehicle exceeds a first threshold and that a vehicle stop duration exceeds a time threshold;
capturing, by a camera on a windshield of the vehicle, a plurality of facial images;
generating, by a cloud platform, confidence scores for each facial image compared against stored driver profiles;
computing, at the cloud platform, based on the confidence scores, a vote count and an average score for a candidate driver profile; and
assigning, by the cloud platform, a driver identifier to a vehicle based on the vote count and average score exceeding respective thresholds.

16. The non-transitory computer-readable storage medium of claim 15, the steps further comprising:
monitoring, by the processor, a head position of a vehicle occupant; and
determining that the head position remains forward-facing for a minimum duration, wherein capturing the plurality of facial images occurs during the minimum duration.

17. The non-transitory computer-readable storage medium of claim 15, wherein computing the vote count at the cloud platform comprises:
determining a number of facial images matching the candidate driver profile;
calculating an average confidence score by summing confidence scores of matching images and dividing by the total number of matching images;
classifying the match as high, medium, or low confidence based on the average confidence score; and
validating the candidate driver profile when either: the confidence is classified as high or the confidence is classified as medium and the candidate driver profile has been associated with the same vehicle within the past 24 hours.

18. The non-transitory computer-readable storage medium of claim 15, the steps further comprising:
maintaining, at the cloud platform, a profile database containing up to a maximum number of facial images per driver;
removing oldest facial images from profiles exceeding an age threshold; and
adding new facial images to profiles below a maximum number.

19. The non-transitory computer-readable storage medium of claim 15, wherein assigning the driver identifier comprises:
determining whether the candidate driver profile is a familiar or unfamiliar profile;
automatically assigning the driver identifier when the candidate driver profile is familiar and the confidence scores exceed an automatic assignment threshold; and
generating an alert for manual assignment when the confidence scores are below the automatic assignment threshold.

20. The non-transitory computer-readable storage medium of claim 15, the steps further comprising:
determining, by the processor, that the plurality of facial images meet quality criteria;
monitoring, by the processor, head position and vehicle speed when the quality criteria are not met; and
capturing a second plurality of facial images when the head position and vehicle speed indicate suitable capture conditions.
